(19) United States
(12) Patent Application Publication
(10) Pub. No.: US 2022/0386590 A1
(43) Pub. Date: Dec. 8, 2022

(54) APPARATUS FOR PREVENTION OF AN ANIMAL ATTACK

(71) Applicant: LYWON RUSSAW, Lehighton, PA (US)

(72) Inventor: LYWON RUSSAW, Lehighton, PA (US)

(21) Appl. No.: 17/471,990

(22) Filed: Sep. 10, 2021

Related U.S. Application Data
(63) Continuation of application No. 63/195,805, filed on Jun. 2, 2021.

(51) Int. Cl. A01M 29/12; A41D 13/00; A41D 1/04; F41H 9/10

(52) U.S. Cl. CPC A01M 29/12; A41D 13/0007; A41D 1/04; F41H 9/10

(57) ABSTRACT

An animal attack prevention suit to protect the lives of both animal and human. A vest includes a housing mechanism for housing a propellant. A propellant control mechanism controls emission of the propellant from the housing mechanism.

### BACKGROUND OF THE INVENTION

### Field of the Invention

The present invention relates to an apparatus for the prevention of an animal attack and specifically relates to an article of clothing worn by a human for emitting a propellent for protecting the lives of both an animal and human.

### Description of the Related Art

Attacks from wild animals on humans can occur. The attacks can occur in the wilderness, such as when the human is hiking or camping. For example, bear attacks can occur when bears are lured to a campsite in search of food.

It is desirable to provide an article of clothing worn by a human for expeditiously emitting a propellent to deter an animal from coming near the human in order to protect both the human and the animal.

### SUMMARY OF THE INVENTION

The present invention relates to an article of clothing worn by a human for expeditiously emitting a propellent. In one embodiment, the article of clothing is a suit including a vest. The vest can include a housing mechanism for housing a propellant. A propellant control mechanism can be used for controlling emission of the propellant from the housing mechanism. In one embodiment, the propellant control mechanism includes a valve. The valve can be coupled to at least one nozzle for dispensing the propellant. One or more of the nozzles can be positioned at one or more positions of the article of clothing to emit the propellant from one or more locations of the article of clothing. Hoses can carry the propellant from the housing mechanism to the one or more nozzles.

The propellant can include a material having an odor or a composition which is disliked by an animal in order to deter the animal from coming towards the human or to scare the animal away. Example suitable propellent materials include bear spray, colored propellant, scents, or capsaicin.

In one embodiment, the present invention provides an animal attack prevention suit to protect the lives of both animal and human. The present invention also provides a bear attack prevention suit that preserve a bear's life. The present invention also provides a bear attack prevention suit that prevents human mauling.

Other objects and advantages of the various embodiments of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application. The invention will be more fully described by reference to the following drawings.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a front view of an interior of the apparatus for prevention of an animal attack in accordance with the teachings of the present invention.

FIG. 2 is a rear view of an interior of the apparatus for prevention of an animal attack.

FIG. 3 is a side view of an exterior of the apparatus for prevention of an animal attack.

FIG. 4 is a side view of an interior of the apparatus for prevention of an animal attack.

FIG. 5 is a front view of an exterior of the apparatus for prevention of an animal attack.

FIG. 6 is a rear view of an exterior of the apparatus for prevention of an animal attack.

FIG. 7 is a front view of an embodiment of the exterior of the apparatus for prevention of an animal attack.

FIG. 8 is a front view of an exterior of the apparatus for prevention of an animal attack.

FIG. 9 is a front view of an interior of the apparatus for prevention of an animal attack.

FIG. 10 is a schematic diagram of an embodiment including a valve for as a propellant control mechanism.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

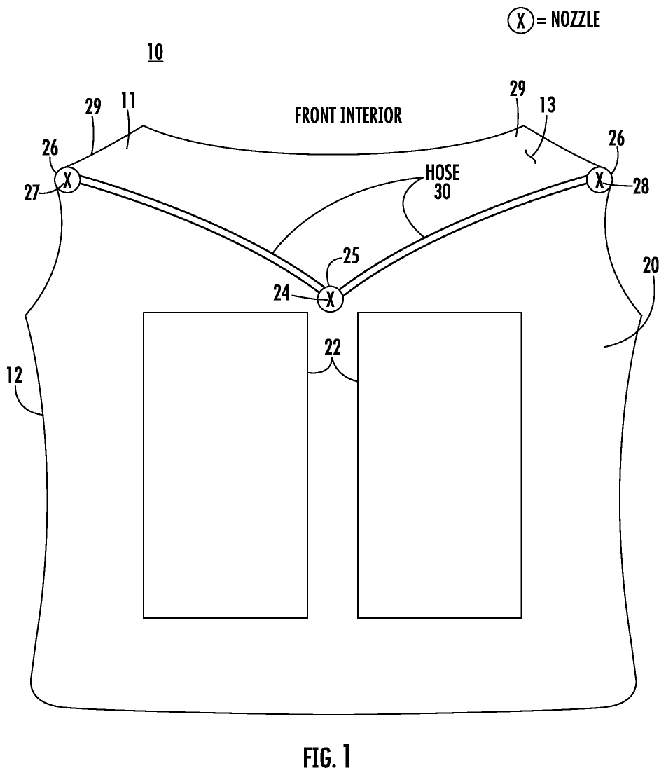

FIGS. 1-6 illustrate apparatus for prevention of an animal attack 10. Apparatus for prevention of an animal attack 10 can include vest 11 and propellant control mechanism 13. Vest 11 can comprise front 12, sides 14 and rear 16. Front 12, sides 14 and rear 16 can be coupled to one another or integral to one another. End 15 of sides 14 can be coupled to front 12 and end 17 sides 14 can be coupled to rear 16. Sides 14 can extend on a right and left side of vest 11 between front 12 and rear 16. In one embodiment, front 12, sides 14 and rear 16 are sewn to one another. Vest 11 can be formed of a lightweight durable materials such as canvas, nylon, cotton, leather, or a synthetic material which is man-made.

Propellant control mechanism 13 is coupled to one or more of chest center nozzle 24, front shoulder nozzles 26, back center nozzle 34, rear shoulder nozzles 36 and side nozzles 44. Hoses 30 can connect one or more of chest center nozzle 24, front shoulder nozzles 26, back center nozzle 34, rear shoulder nozzles 36 and side nozzles 44 to one another or to propellant control mechanism 13. Propellant control mechanism 13 can include for example a pump or atomizer which when activated can expel propellant 51 from one or more of chest center nozzle 24, front shoulder nozzles 26, back center nozzle 34, rear shoulder nozzles 36 and side nozzles 44. In one embodiment, propellant 51 is expelled as a mist. Suitable materials for propellant 51 include bear spray, colored propellant, scents, or capsaicin

Referring to FIG. 1, inside surface 20 of vest 11 can include one or more compartments 22. Compartments 22 can be used as pockets. Chest center nozzle 24 is positioned at center 25 of inside surface 20 of front 12. Front shoulder nozzles 26 are positioned at side 27 and side 28 of shoulder area 29. Hose 30 is connected between center nozzle 24 and front shoulder nozzles 26 positioned at side 27 and side 28 of shoulder area 29.

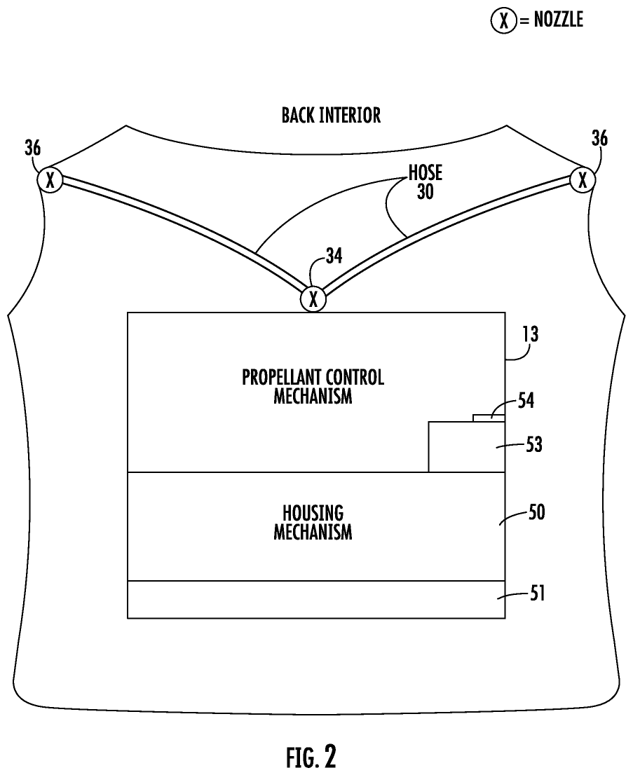

Referring to FIG. 2, back center nozzle 34 is positioned at center 35 of inside surface 20 of rear 16. Rear shoulder nozzles 36 are positioned at side 37 and side 38 of shoulder area 29. Hose 30 is connected between back center nozzle 34 and rear shoulder nozzle. Propellant housing 50 can be positioned on inside surface of rear 16. Propellant control mechanism 13 can control the emittance of propellant 51 from propellant housing 51. Propellant control mechanism 13 can include one or more pumps 53 activated by pump activation switches 54. Pump 53 can be battery operated.

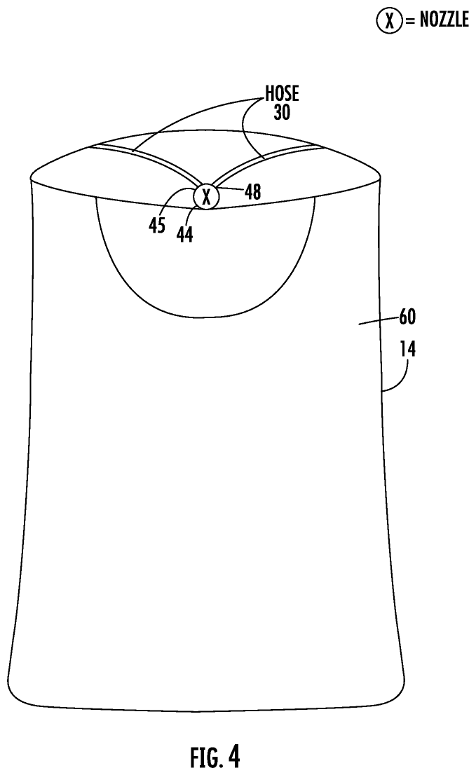

Referring to FIG. 4, side nozzle 44 is positioned at center 45 of inside surface 20 of sides 14. Hoses 30 extend from side 47 and side 48 of side nozzle 44. Hoses 30 can connect to propellant control mechanism 13.

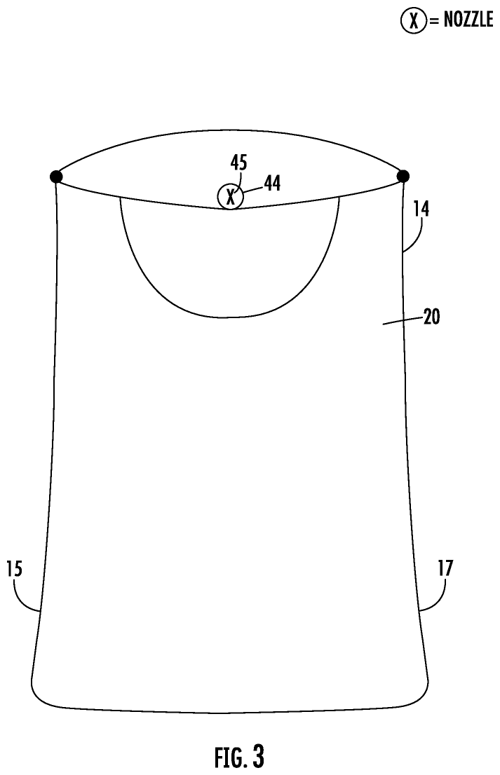

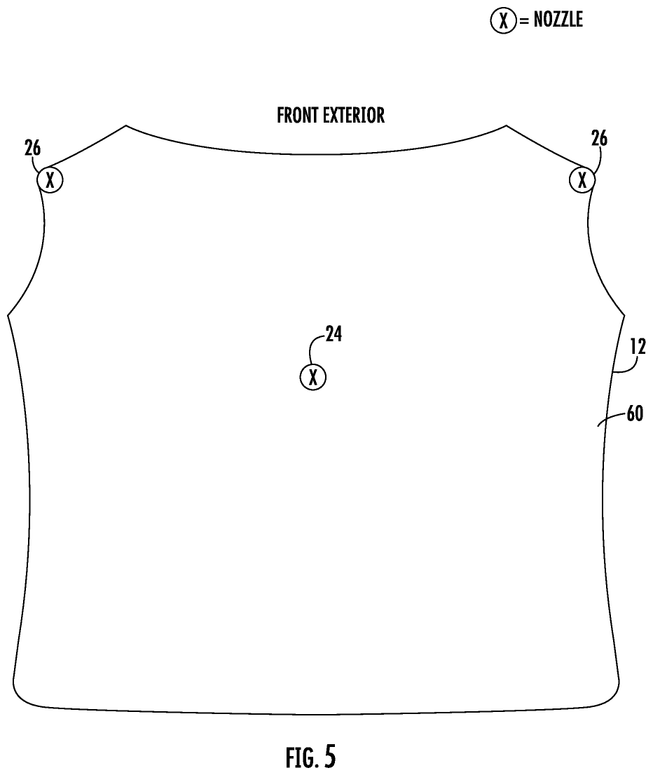

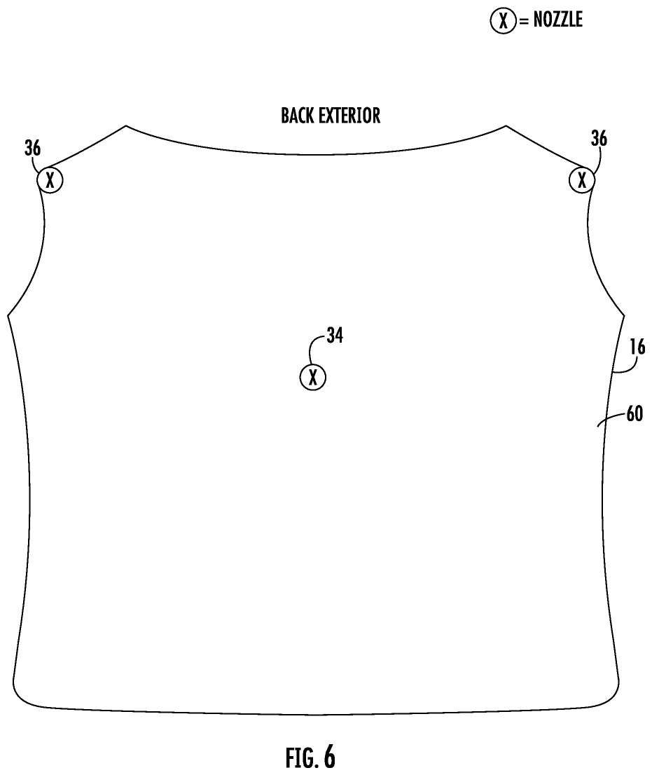

Side nozzle 44 extends to outside surface 60 of sides 14 as shown in FIG. 3. Chest center nozzle 24 and front shoulder nozzles 26 extend to outside surface 60 of front 12 as shown in FIG. 5. Back center nozzle 34 and rear shoulder nozzles 36 extend to outside surface 60 of rear 16 as shown in FIG. 6. Chest center nozzle 24, front shoulder nozzles 26, back center nozzle 34, rear shoulder nozzles 36, side nozzles 44 and hoses 30 can be used to expel propellant 51 as a spray.

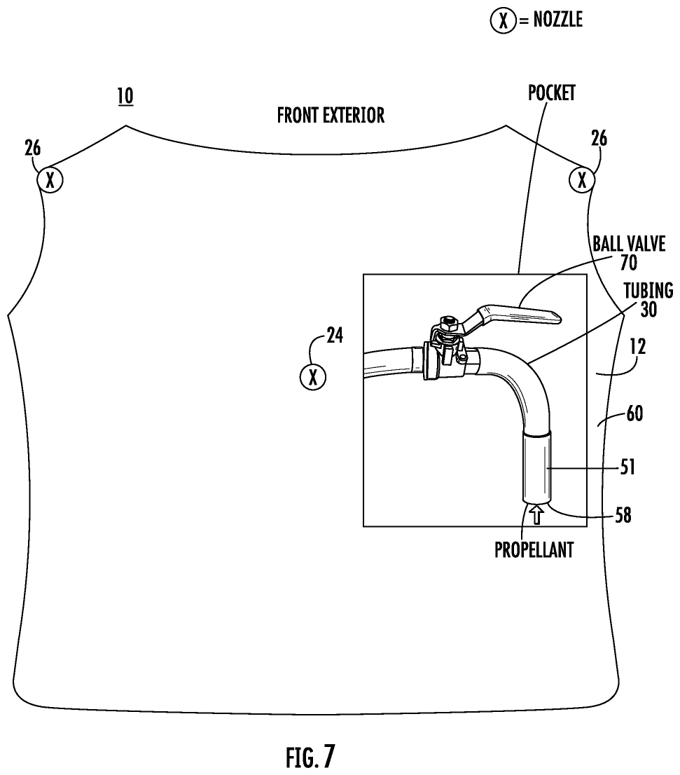

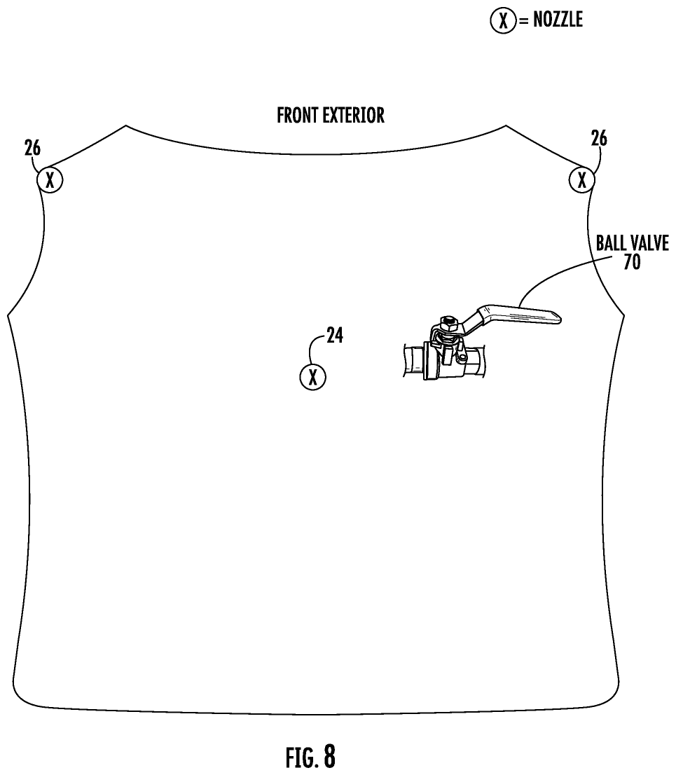

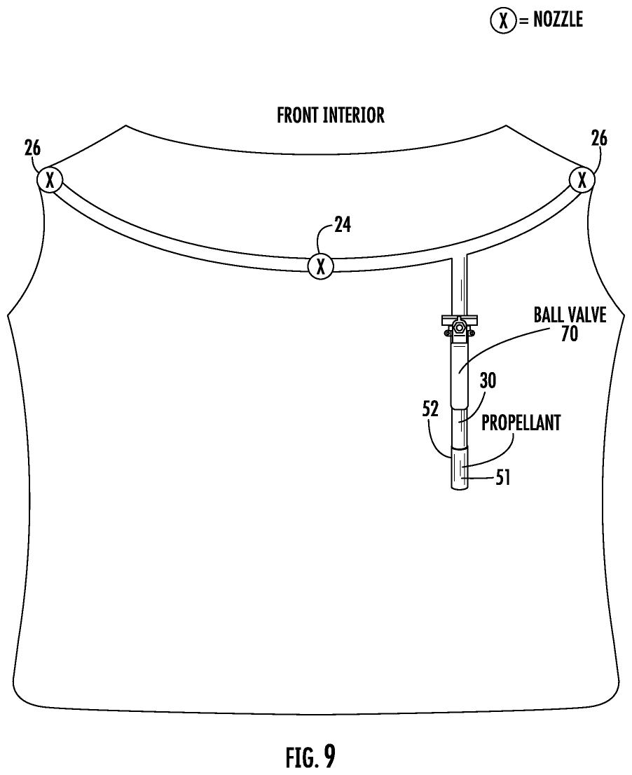

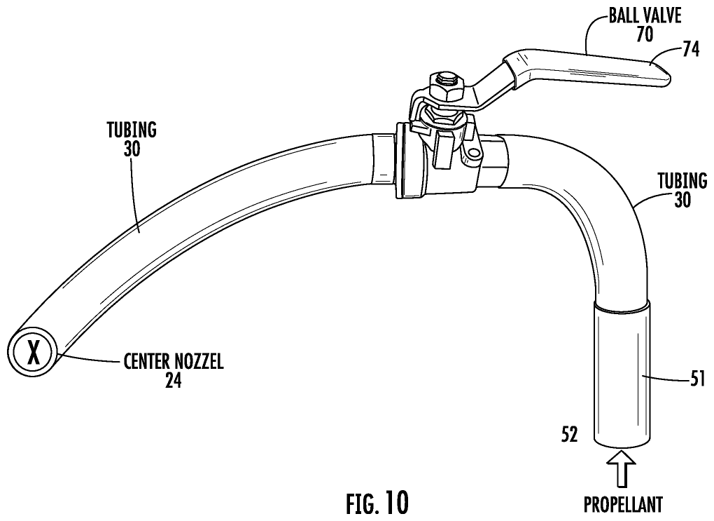

FIGS. 7-9 illustrate an embodiment of apparatus for prevention of an animal attack 10 in which propellent control mechanism 13 includes valve control device 70. Propellant housing 50 includes container 52. Container 52 can be received in compartment 72. Valve control device 70 can be coupled to chest center nozzle 24. Hoses 30 shown in FIGS. 1-6 and can be used to control operation of one or more of chest center nozzle 24, front shoulder nozzles 26, back center nozzle 34, rear shoulder nozzles 36, side nozzles 44 to expel propellant 51 from container 52. In one embodiment, valve control device 70 comprises a ball valve. Valve control device 70 can include valve arm 74 as shown in FIG. 10. Valve arm 74 can be moved between an open and closed position for opening and closing valve control device 70. In the open position, propellant 51 transferred from container 52 through hoses 30 to chest center nozzle 24 and is expelled from chest center nozzle. Propellant 51 can also be transferred from chest center nozzle 24 through hoses 30 to one or more of front shoulder nozzles 26, back center nozzle 34, rear shoulder nozzles 36, side nozzles 44 to expel propellant 51 therefrom.

It is to be understood that the above described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. An apparatus for prevention of an animal attack comprising:
an article of clothing;
one or more nozzles extending from the article of clothing;
a housing mechanism configured for receiving a propellant; and
a propellant control mechanism for controlling emission of the propellant from the housing mechanism to the one or more nozzles.

2. The apparatus of claim 1 wherein the article of clothing is a vest, the vest comprises a front, the front coupled or integral to a first end of a first and a second side, and a second end of the first and the second side being coupled or integral with a rear.

3. The apparatus of claim 2 wherein the one or more nozzles are a chest center nozzle positioned at a center of an inside surface of the front, and a first and a second front shoulder nozzle positioned respectively at a first side and a second side of a front shoulder area and further comprising a hose connected between the chest center nozzle and the first and the second front shoulder nozzles.

4. The apparatus of claim 2 wherein the one or more nozzles are a back center nozzle positioned at a center of an inside surface of the rear, and a first and a second rear shoulder nozzle positioned respectively at a first side and a second side of a rear shoulder area and further comprising a hose connected between the back center nozzle and the first and the second rear shoulder nozzles.

5. The apparatus of claim 2 wherein the one or more nozzles are a side nozzle positioned at a center of an inside surface of the first and the second side and further comprising a hose connected between the first and the second side nozzles.

6. The apparatus of claim 1 wherein the propellant control mechanism is a pump.

7. The apparatus of claim 6 wherein the propellant control mechanism further comprises a pump activation switch.

8. The apparatus of claim 1 wherein the propellant control mechanism is a ball valve.

9. The apparatus of claim 8 wherein the housing mechanism is a container.

10. The apparatus of claim 1 wherein the propellant is one or more of a bear spray, colored propellant, scent, or capsaicin.

11. The apparatus of claim 1 The apparatus of claim 1 wherein the article of clothing is formed of canvas, nylon, cotton, leather, or a synthetic material.

12. The apparatus of claim 1 wherein the propellant is emitted from the one or nozzles as a spray.

13. A method for preventing an animal attack comprising:
providing an article of clothing comprising one or more nozzles extending from the article of clothing, a housing mechanism including a propellant, the one or more nozzles being coupled to the housing mechanism and a propellant control mechanism coupled to the housing mechanism; and
activating the propellant control mechanism for emitting the propellant from the housing mechanism to the one or more nozzles.

14. The method of claim 13 wherein the propellant is emitted from the one or nozzles as a spray.

15. The method of claim 13 wherein the propellant is one or more of a bear spray, colored propellant, scent, or capsaicin.

16. The method of claim 13 wherein the propellant control mechanism is a ball valve

17. The method of claim 16 wherein the housing mechanism is a container.

18. The method of claim 13 wherein the propellant control mechanism is a pump.

19. The method of claim 18 wherein the propellant control mechanism further comprises a pump activation switch.

20. The method of claim 13 wherein the article of clothing is a vest, the vest comprises a front, the front coupled or integral to a first end of a first and a second side, and a second end of the first and the second side being coupled or integral with a rear, wherein the one or more nozzles are a chest center nozzle positioned at a center of an inside surface of the front, a first and second front shoulder nozzle positioned respectively at a first side and a second side of a front shoulder area, a back center nozzle positioned at a center of an inside surface of the rear, a first and a second rear shoulder nozzle positioned respectively at a first side and a second side of a rear shoulder area, a side nozzle positioned at a center of an inside surface of the first and the second side and further comprising a hose connected between the chest center nozzle, the first and the second front shoulder nozzles, the back center nozzle and the first and the second rear shoulder nozzles and the first and the second side nozzles.
